(19) United States
(12) Patent Application Publication
(10) Pub. No.: US 2020/0187635 A1
(43) Pub. Date: Jun. 18, 2020

(54) SKINCARE DEVICE HAVING OPTIMIZED DUAL ENERGY MODALITIES, AND ASSOCIATED SYSTEMS AND METHODS

(71) Applicant: L'Oreal, Paris (FR)

(72) Inventor: Robert E. Akridge, Redmond, WA (US)

(73) Assignee: L'Oreal, Paris (FR)

(21) Appl. No.: 16/224,608

(22) Filed: Dec. 18, 2018

(51) Int. Cl. A46B 13/02; A46B 13/00

(52) U.S. Cl. CPC A46B 13/023; A61H 23/02; A46B 13/008

(57) ABSTRACT

A skincare device having optimized dual energy modalities ace is presented. In an embodiment, a skincare device includes a body having protruding elements configured for contacting a skin of a user, where the protruding elements are configured to vibrate in operation. The skincare device also includes an end effector configured for contacting the skin of the user, where the end effector is configured to oscillate about a center axis in operation.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a skincare device includes a body having protruding elements configured for contacting a skin of a user, where the protruding elements are configured to vibrate in operation. The skincare device also includes an end effector configured for contacting the skin of the user, where the end effector is configured to oscillate about an axis during operation.

In an aspect, the body carries a resonant structure configured to generate vibrations of the protruding elements. In another aspect, the resonant structure includes: a first resonant structure configured to resonate at a first resonant frequency; and a second resonant structure configured to resonate at a second resonant frequency. The first resonant frequency may be different from the second resonant frequency.

In an aspect, the protruding elements comprise a first plurality of protruding elements having a first size and a second plurality of protruding elements having a second size different from the first size. The first resonant structure is configured to impart the first resonant frequency onto the first plurality of protruding elements, and the second resonant structure is configured to impart the second resonant frequency onto the second plurality of protruding elements.

In an aspect, the first plurality of protruding elements has a first shape and the second plurality of protruding elements has a second shape different from the first shape.

In an aspect, the resonant structure is a metal wire or strip caused to vibrate at least in part by oscillations of the end effector.

In another aspect, the resonant structure includes at least one piezoelectric element configured to constrict and expand based on a voltage supplied to the piezoelectric element.

In an aspect, the resonant structure extends radially away from the end effector.

In an aspect, the end effector is a face brush.

In an aspect, the vibration of the protruding elements is at least in part caused by oscillations of the end effector. In an aspect, the end effector carries at least one rotating first magnet and the body carries at least one stationary second magnet opposite from the rotating first magnet. The protruding elements vibrate at least in part based on magnetic interactions between the at least one rotating first magnet and the at least one stationary second magnet.

In an aspect, the body comprises an opening for a hand of the user. In another aspect, the body is made of silicon material.

In an aspect, the skincare device also includes a first charging coil carried by a charging stand, and a second charging coil carried by the body, where the first charging coil is configured to receive electrical energy through electromagnetic interactions with the second charging coil.

In an aspect, the body comprises a printed circuit board (PCB) with a controller configured to control operation of the end effector.

In one embodiment, a skincare device includes: an oscillating brush head configured to contact a skin of a user; and a body having protruding elements configured to contact the skin of the user, where the protruding elements are configured to vibrate in response to a source of vibrations.

In an aspect, the source of vibrations is a resonant structure carried by the body. In another aspect, the resonant structure is a piezoelectric element configured to constrict and expand based on a voltage supplied to the piezoelectric element.

In an aspect, the resonant structure extends radially away from the end effector.

In an aspect, the resonant structure includes: a first resonant structure configured to resonate at a first resonant frequency; and a second resonant structure configured to resonate at a second resonant frequency, where the first resonant frequency is different from the second resonant frequency.

In an aspect, the protruding elements include a first plurality of protruding elements having a first size and a second plurality of protruding elements having a second size different from the first size. The first resonant structure is configured to impart the first resonant frequency onto the first plurality of protruding elements, and the second resonant structure is configured to impart the second resonant frequency onto the second plurality of protruding elements.

In an aspect, the skincare device also includes: a motor, a shaft mechanically connecting the motor with the oscillating brush head; a first plurality of magnets carried by the oscillating brush head; and a second plurality magnets carried by the body. The second plurality of magnets faces the first plurality of magnets at least at some angular positions of the oscillating brush head. The resonant structure is a plurality of metal wires or strips configured to vibrate at least in part based on interactions between the first plurality of magnets and the second plurality of magnets.

### DESCRIPTION OF THE DRAWINGS

The foregoing aspects and the attendant advantages of the inventive technology will become more readily appreciated as the same become better understood by reference to the following detailed description, when taken in conjunction with the accompanying drawings, wherein:

FIG. 1A is a front plan view of a skincare device in accordance with an embodiment of the present technology;

FIG. 1B is a cross-sectional side view of the skincare device shown in FIG. 1A;

FIG. 1C is a back plan view of the skincare device shown in FIG. 1A;

FIG. 2 is a partial plan view of a skincare device in accordance with an embodiment of the present technology;

FIG. 2A is a front plan view of a face brush in accordance with an embodiment of the present technology;

FIG. 2B is a side view of the face brush shown in FIG. 2B;

FIG. 3 is a partially schematic view of a skincare device in accordance with an embodiment of the present technology;

FIG. 4A is a side view of a skincare device in accordance with an embodiment of the present technology;

FIG. 4B is a back view of a skincare device shown in FIG. 4A;

FIGS. 5A and 5B are detail views of the skincare device shown in FIG. 4B; and

FIG. 5C is a cross-sectional view of the Detail A of FIG. 5A.

### DETAILED DESCRIPTION

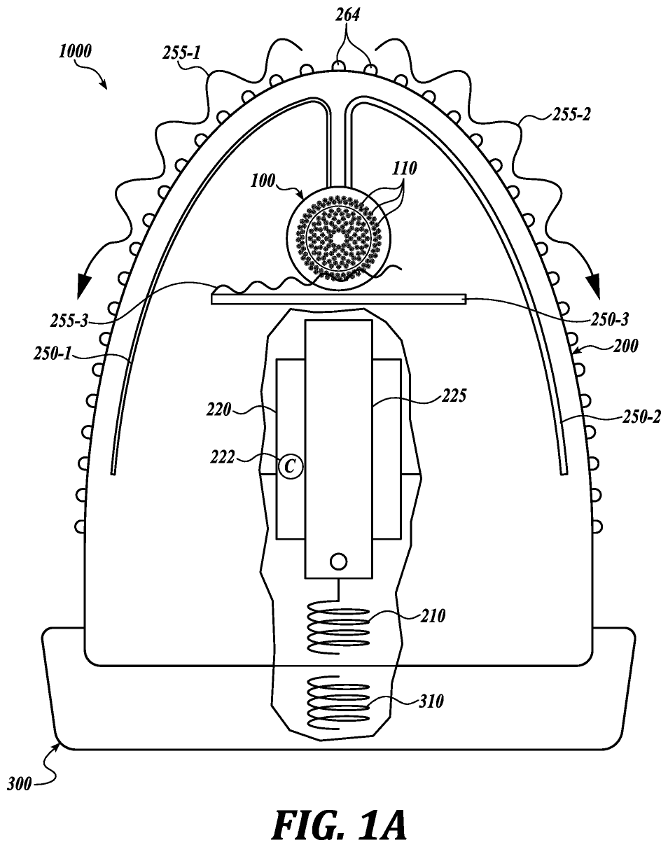

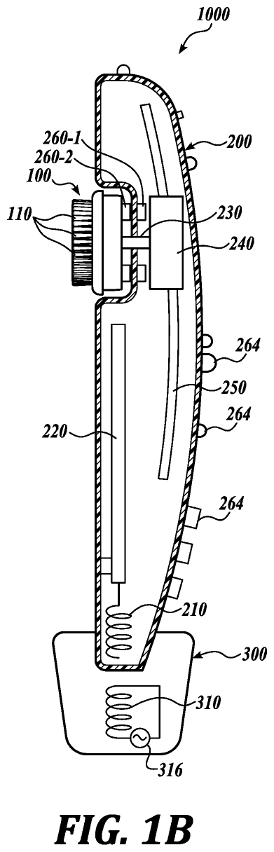

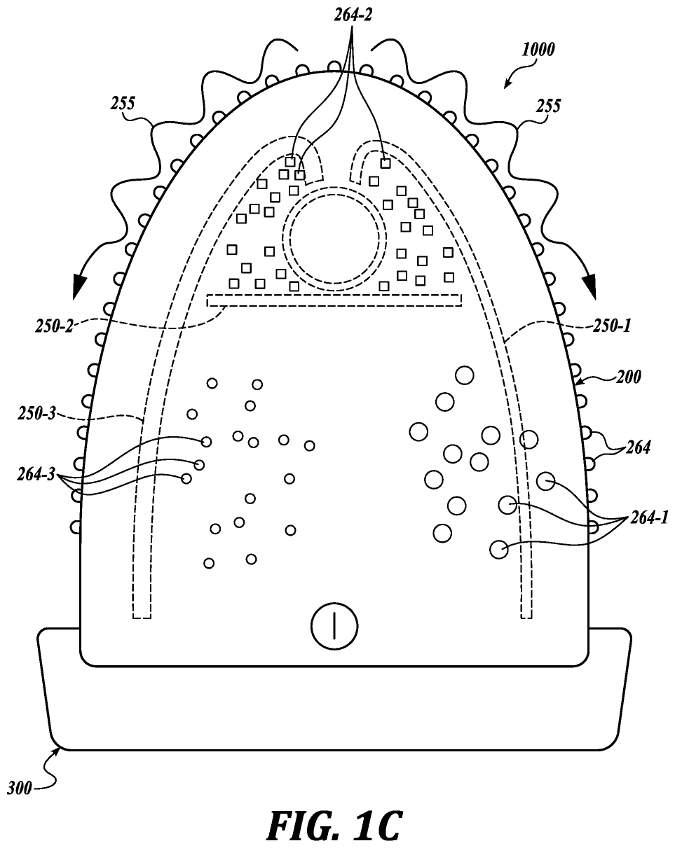

The following disclosure describes various embodiments of systems and associated methods for measuring and indicating brush head life. A person skilled in the relevant art will also understand that the technology may have additional embodiments, and that the technology may be practiced without several of the details of the embodiments described below with reference to FIGS. 1-5C.

Briefly described, skincare devices and methods having dual energy modalities are described herein. In some embodiments, the device includes an oscillating end effector and a plurality of protruding elements (also referred to as “bead heads” or “vibratory beads”) distributed over the outer surface of the device. In operation, the end effector (e.g., a face brush) oscillates to impart motion onto skin of a user. These oscillations of the end effector may provide vibratory excitations to the protruding elements. The protruding elements are in contact with skin of the user, and they vibrate skin of the user in addition to the action of the end effector. The inventive device may include an opening for user's hand for improved handling of the specific areas of the user's skin.

In some embodiments, the vibrations that originate at the end effector are transferred to the protruding elements through resonant structures (e.g., through passive resonant structures). In other embodiments, the vibrations of the protruding elements are generated by the resonant structures themselves (e.g., by active resonant structures). A non-limiting example of such active resonant structure is a piezo element that expands and constricts in response to the application of alternate current (AC) source.

In some embodiments, the resonant structure includes wires or strips of material, for example metals. Different part of the resonant structure may be designed and sized to resonate at different frequencies. For example, one part of the resonant structure may resonate at a lower frequency than another part of the resonant frequency. Without being bound to theory, it is believed that lower frequencies of vibration affect deeper layers of tissue, while higher frequencies of vibration affect more topical layers of tissue. Furthermore, without being bound to theory, it is believed that different frequencies of the protruding elements in contact with skin may have different thermal effects on the skin. In some embodiments, multiple vibration frequencies and/or thermal effects at the skin of user enhance therapeutic outcomes or pleasure sensation of the user. These multiple vibration frequencies and thermal effects are collectively referred to as dual energy or multi energy modalities.

FIG. 1A is a front plan view of a skincare device in accordance with an embodiment of the present technology. In some embodiments, the skincare device 1000 is a face brush having a brush head 100 that oscillates about a center axis when in operation. The oscillatory motion of the brush head 100 may cause vibrations that are transferred through resonant structures 250 onto protruding elements 264. The peripherally distributed protruding elements 264 are illustrated in FIG. 1A, but other distributions of the protruding elements 264 are also possible.

In some embodiments, the resonant structures 250 include metal profiles (e.g., metal lines, metal strips, metal wires, etc.). The illustrated resonant structures 250 are distributed symmetrically with respect to the centerline of the device, but other distributions, for example non-symmetrical, are also possible.

Different parts of the resonant structures 250 may have different resonant properties (e.g., resonant frequencies) that promote different vibration modes. For example, the resonant structure 250-1 may be relatively thin having a relatively small area moment of inertia (bending moment), thus resulting in a relatively low resonant frequency f1. On the other hand, the resonant structure 250-3 may be relatively thick and short, thus having a relatively high resonant frequency f3. Resonant properties of the resonant structure 250-2 may be between those of the resonant structures 250-1 and 250-3, thus having a resonant frequency f2 that is between frequencies f1 and f3. Therefore, by sizing and shaping individual resonant structures 250 of the device, different zones of the skincare device 1000 may be designed and optimized to have different vibration frequencies.

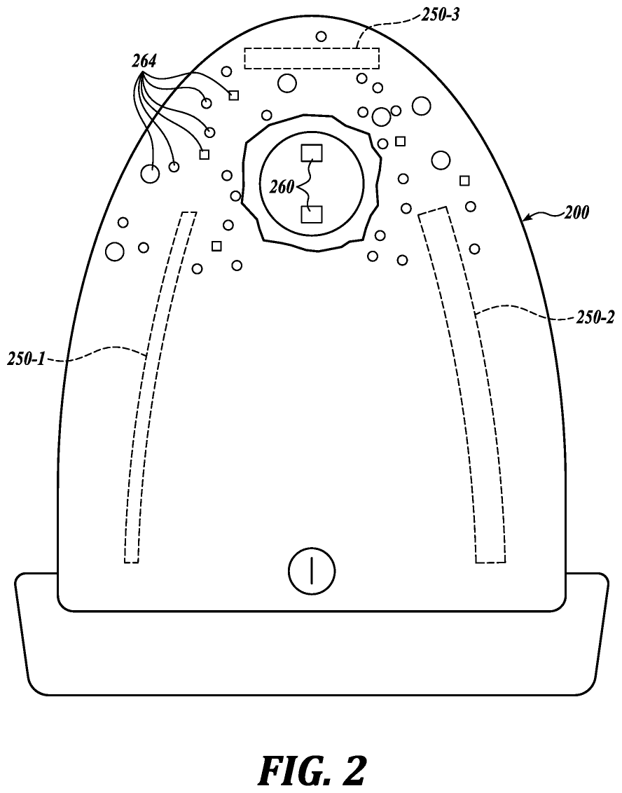

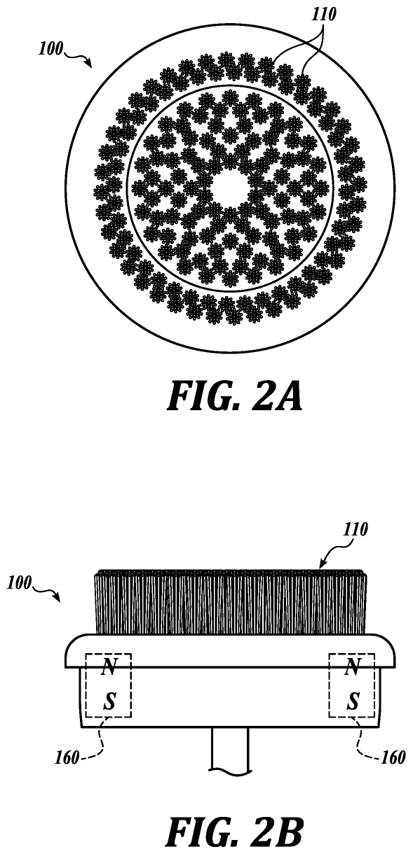

In some embodiments, the device 1000 is manufactured of soft materials, for example, latex, soft rubber or soft plastic. The protruding elements 264 may be manufactured of soft or hard materials, for example, hard plastic or rubber. In different embodiments, the protruding elements 264 may have different size and/or shape as described below with reference to FIG. 1C and FIG. 2.

The skincare device 1000 may be controlled by a controller 222 that is carried by a circuit board 220. The device 1000 may be powered by a battery 225 and/or pairs of charging coils 210/310. The device 1000 may be rechargeable through a charging stand 300.

FIG. 1B is a cross-sectional side view of the skincare device 1000 shown in FIG. 1A. In operation, the brush head 100 is driven to oscillate about a central axis by a shaft 230, while bristles 110 contact skin of the user. A motor 240 may be powered from a source of alternating current 316 through the charging course 210/310.

In some embodiments, a housing 200 carries a plurality of magnets 260-1, and the brush head 100 carries the opposing plurality of magnets 260-2. As the magnets 260-2 oscillate around the center axis, the opposing magnets experience attractive and repulsive forces as different magnetic poles face each other, resulting in vibrations of the housing 200. These vibrations may be transferred to the resonant structure 250 and further to the protruding elements 264, as explained with reference to FIG. 1C below.

FIG. 1C is a back plan view of the skincare device shown in FIG. 1A. The illustrated skincare device 1000 includes several groups of protruding elements 264. In operation, these different groups of the protruding elements 264 may vibrate at different frequencies, based on their proximity to one or more resonant structures 250. For example, the protruding elements 264-1 may vibrate at the relatively low resonant frequency f1 of the resonant structure 250-1. Without being bound to theory, it is believed that a relatively large size of the protruding elements 264-1 coupled with a relatively low vibration frequency f1 may result in, for example, enhanced thermal effects on skin of the user and/or increased depth of the tissue treatment. Conversely, a relatively small size of the protruding elements 264-3 coupled with a relatively high vibration frequency f3 may result in a decreased depth of the tissue treatment. In some embodiments, the protruding elements 264-1, 264-2 and 264-3 have different shapes. In the illustrated embodiment, three groups of the protruding elements 264 are shown. However, different embodiments of the skincare device may include different number of groups of protruding elements.

FIG. 2 is a partial plan view of a skincare device 1000 in accordance with an embodiment of the present technology. In this partial view, the brush head 100 is removed making the magnets 260 visible in the housing 200. In other embodiments, elements 260 may be other sources of vibration, for example, piezo elements that vibrate in response to an alternate current.

The illustrated embodiment of the skincare device includes protruding elements 264 with different sizes and shapes. These protruding elements may vibrate at different frequencies based on frequencies of oscillation of the resonant structures 250.

FIG. 2A is a front plan view of a face brush in accordance with an embodiment of the present technology. The illustrated face brush 100 includes bristles 110 that contact user's skin as the brush head 100 oscillates. FIG. 2B is a side view of the face brush shown in FIG. 2A. The face brush 100 includes a plurality of magnets 260 having the north poles facing the bristles 110 and the south poles facing the opposing magnets of the housing (not shown). In different embodiments, the N-S orientation and the number of magnets 260 may be different.

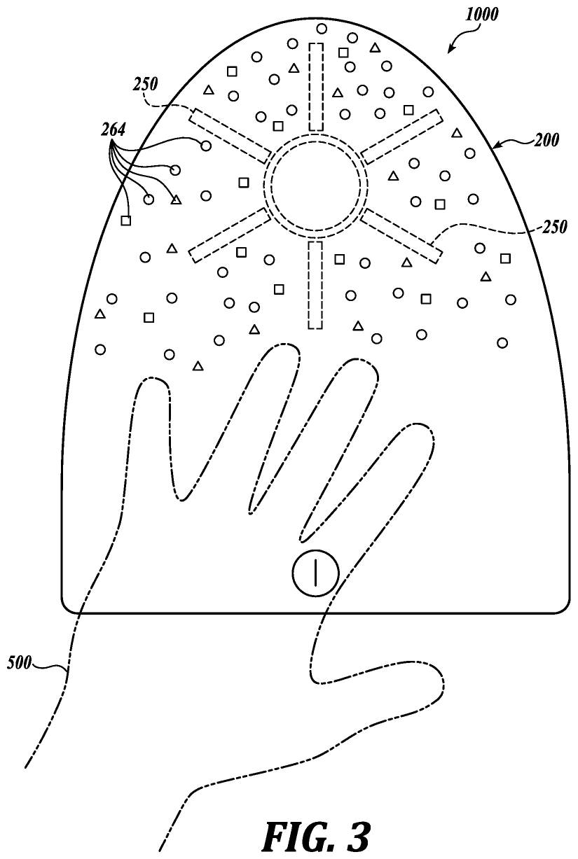

FIG. 3 is a partially schematic view of a skincare device in accordance with an embodiment of the present technology. In some embodiments, the skincare device 1000 may include an opening for user's hand 500. In operation, the user may bring the skincare device 1000 into contact with face to achieve, for example, desired face massage or thermal effects. Illustrated skincare device 1000 includes a set of radially arranged resonant structures 250, but other arrangements are also possible. The illustrated protruding elements 264 may have different size, hardness, smoothness of their outer surface, thermal properties, or other properties relevant to tactile or thermal sensation of the user.

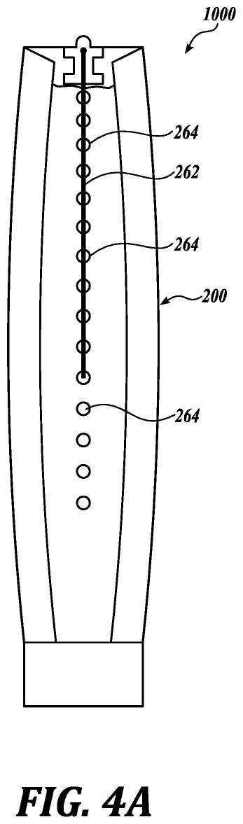

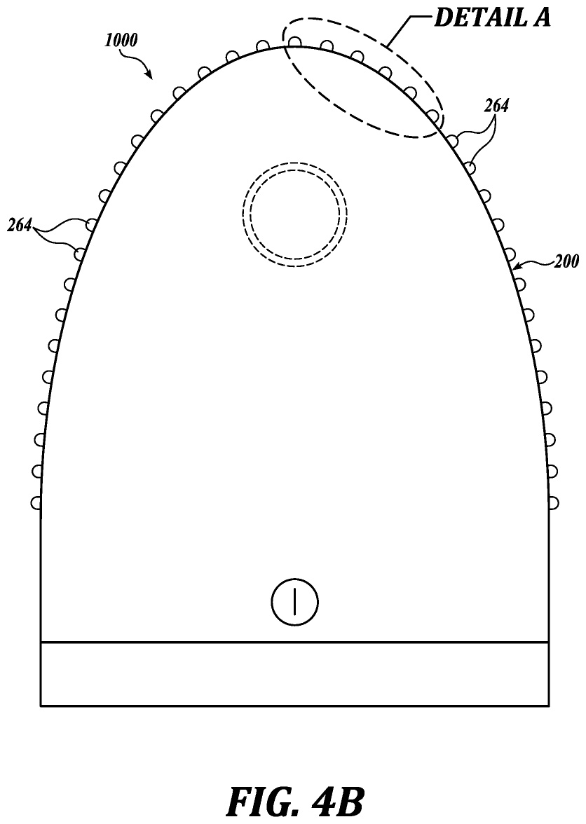

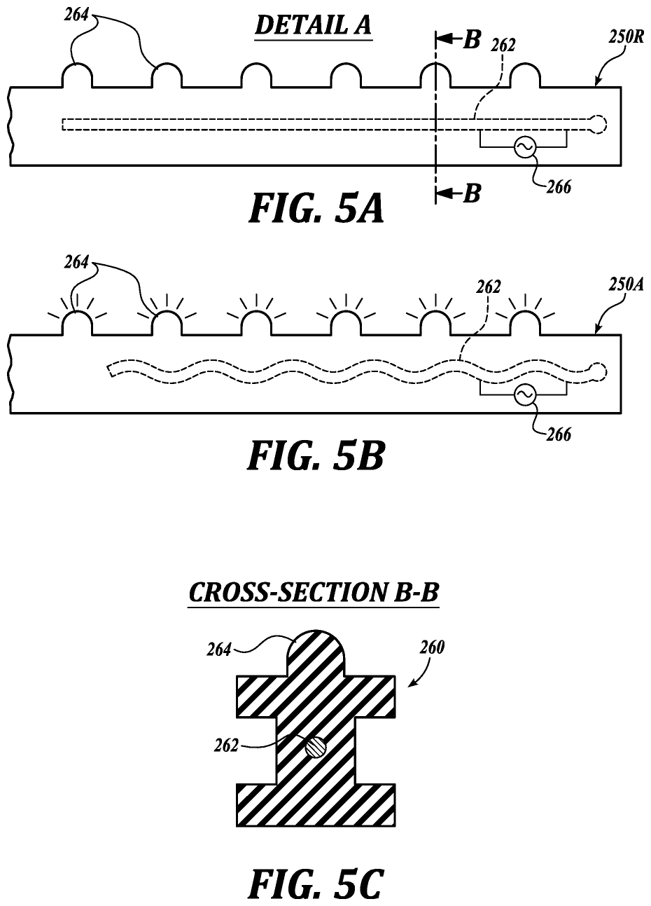

FIG. 4A is a side view of a skincare device in accordance with an embodiment of the present technology. The illustrated embodiment includes an active resonant structure 262 that vibrates the protruding elements 264. FIG. 4B is a back view of a skincare device shown in FIG. 4A. The protruding elements 264 are arranged along the side edges of the skincare device 1000, but in different embodiments the protruding elements 264 may be arranged in other zones of the skincare device. For example the protruding elements 264 may be arranged over the front and back sides of the skincare device 1000. Detail A of FIG. 4B is shown in FIGS. 5A-5C.

FIGS. 5A and 5B are detail views of the skincare device shown in FIG. 4B. FIG. 5A illustrates the resonant structure 262 in its unpowered or inactive state. FIG. 5B illustrates the resonant structure 262 in its powered or active state. The resonant structure 262 may be a piezo element connected to source of AC voltage. When in its active state, the resonant structure 262 is energized by AC voltage from the source of energy 266. Generally, a frequency of the source 266 determines vibration frequency of the resonant structure 262, therefore at least in part determining vibration frequency of the protruding elements 264. In some embodiments, vibration frequency of the resonant structure 262 can be a multiple or a fraction of the frequency of the AC source 266. The illustrated embodiment includes a single resonant structure 262 powered by one AC source 266. However, in different embodiments the skincare device may include multiple resonant structures 262 that are powered by dedicated AC sources 266 operating at different frequencies.

FIG. 5C is a cross-sectional view of the Detail A of FIG. 5A. In the illustrated embodiment, the resonant structure 262 and the protruding elements 264 comprise a vibration transducer 260. The resonant structure 262 may be embedded into material that carries the protruding element 264. In some embodiments, the size and/or shape of the cross-section of the resonant structure 262 may at least in part determine the amplitude of oscillation of the protruding elements, while the frequency of the AC source 266 determines the frequency of the vibrations.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

From the foregoing, it will be appreciated that specific embodiments of the technology have been described herein for purposes of illustration, but that various modifications may be made without deviating from the disclosure. For example, in some embodiments the counter or controller may be based on a low-power buck regulator connected to a capacitor. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Accordingly, the disclosure can encompass other embodiments not expressly shown or described herein.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” etc., mean plus or minus 5% of the stated value.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

I/We claim:

1. A skincare device, comprising:
a body having protruding elements configured for contacting a skin of a user, wherein the protruding elements are configured to vibrate during operation; and
an end effector configured for contacting the skin of the user, wherein the end effector is configured to oscillate about an axis during operation.

2. The device of claim 1, wherein the body carries a resonant structure operably coupled to one or more of the protruding elements, the resonant structure configured to generate vibrations of the one or more protruding elements.

3. The device of claim 2, wherein the resonant structure comprises:
a first resonant structure configured to resonate at a first resonant frequency; and
a second resonant structure configured to resonate at a second resonant frequency,
wherein the first resonant frequency is different from the second resonant frequency.

4. The device of claim 3, wherein the protruding elements comprise a first plurality of protruding elements having a first size and a second plurality of protruding elements having a second size different from the first size, and wherein:
the first resonant structure is configured to impart the first resonant frequency onto the first plurality of protruding elements; and
the second resonant structure is configured to impart the second resonant frequency onto the second plurality of protruding elements.

5. The device of claim 4, wherein the first plurality of protruding elements has a first shape and the second plurality of protruding elements has a second shape different from the first shape.

6. The device of claim 2, wherein the resonant structure is a metal wire or strip caused to vibrate at least in part by oscillations of the end effector.

7. The device of claim 2, wherein the resonant structure comprises at least one piezoelectric element configured to constrict and expand based on a voltage supplied to the piezoelectric element.

8. The device of claim 2, wherein the resonant structure extends radially away from the end effector.

9. The device of claim 1, wherein the end effector is a face brush.

10. The device of claim 1, wherein vibration of the protruding elements is at least in part caused by oscillations of the end effector.

11. The device of claim 10, wherein the end effector carries at least one rotating first magnet and the body carries at least one stationary second magnet opposite from the rotating first magnet, and wherein the protruding elements vibrate at least in part based on magnetic interactions between the at least one rotating first magnet and the at least one stationary second magnet.

12. The device of claim 1, wherein the body comprises an opening for a hand of the user.

13. The device of claim 1, wherein the body is made of silicon material.

14. The device of claim 1, further comprising:
a first charging coil carried by a charging stand; and
a second charging coil carried by the body,
wherein the first charging coil is configured to receive electrical energy through electromagnetic interactions with the second charging coil.

15. The device of claim 1, wherein the body comprises a printed circuit board (PCB) with a controller configured to control operation of the end effector.

16. A skincare device, comprising:
an oscillating brush head configured to contact a skin of a user; and
a body having protruding elements configured to contact the skin of the user, wherein the protruding elements are configured to vibrate in response to a source of vibrations.

17. The device of claim 16, wherein the source of vibrations is a resonant structure carried by the body.

18. The device of claim 17, wherein the resonant structure is a piezoelectric element configured to constrict and expand based on a voltage supplied to the piezoelectric element.

19. The device of claim 17, wherein the resonant structure extends radially away from the end effector.

20. The device of claim 17, wherein the resonant structure comprises:
a first resonant structure configured to resonate at a first resonant frequency; and
a second resonant structure configured to resonate at a second resonant frequency,
wherein the first resonant frequency is different from the second resonant frequency.

21. The device of claim 20, wherein the protruding elements comprise a first plurality of protruding elements having a first size and a second plurality of protruding elements having a second size different from the first size, and wherein:
the first resonant structure is configured to impart the first resonant frequency onto the first plurality of protruding elements; and
the second resonant structure is configured to impart the second resonant frequency onto the second plurality of protruding elements.

22. The device of claim 16, further comprising:
a motor;
a shaft mechanically connecting the motor with the oscillating brush head;
a first plurality of magnets carried by the oscillating brush head; and
a second plurality magnets carried by the body, where the second plurality of magnets faces the first plurality of magnets at least at some angular positions of the oscillating brush head,
wherein the resonant structure is a plurality of metal wires or strips configured to vibrate at least in part based on interactions between the first plurality of magnets and the second plurality of magnets.
